(19) United States
(12) Patent Application Publication
(10) Pub. No.: US 2005/0177378 A1
(43) Pub. Date: Aug. 11, 2005

(54) Intellectual property right selling/buying system, intellectual property right selling/buying method, program thereof, and recording medium

(76) Inventor: Takao Tazawa, Kanagawa (JP)

Correspondence Address: BRINKS HOFER GILSON & LIONE, P.O. BOX 10395, CHICAGO, IL, 60610, US

(21) Appl. No.: 10/514,602

(22) PCT Filed: Jul. 29, 2003
(86) PCT No.: PCT/JP03/09590

(30) Foreign Application Priority Data
Jul. 30, 2002 (JP) 2002-221867

(51) Int. Cl. G06F 17/60

(52) U.S. Cl. 705/1; 705/10; 705/400

(57) ABSTRACT

An intellectual property right is listed at an appropriate price by monitoring an initial price set by a broker, and circulation of the intellectual property right is promoted. A Web site references a database including a right situation of a right to be sold and evaluation data used to evaluate the right, determines the value evaluation price of the right to be sold, acquires a listing initial price to be input according to the value evaluation price determined here, and invalidates the initial price if the initial value exceeds a predetermined upper limit price. Here, the predetermined upper limit price is calculated by α×(1+γ) wherein α is a value evaluation price to be calculated and γ is a coefficient in a range of 0<γ<1.

### TECHNICAL FIELD

The present invention relates to an intellectual property right selling/buying system for performing selling/buying an intellectual property right in a trading market, specifically relates to an intellectual property right selling/buying system, an intellectual property right selling/buying method, a program thereof, and a recording medium, whereby an intellectual property right such as a patent right, utility model right, right to receive these, and a license by agreement (exclusive license, or non-exclusive license) is sold or bought in a trading market, and also these rights are transferred to a broker by acquiring a call option fee.

### BACKGROUND ART

Nowadays, the environment surrounding intellectual property rights is such as described below. Let us say that a certain venture business enterprise or the like has excellent technical capabilities, but in some cases, cannot expand due to lack of funds. Intellectual property rights (especially patent rights) possessed by the enterprise could serve as an opportunity for business expansion. A venue for opportunities is desired strongly.

Also, of intellectual property rights possessed by enterprises or universities, in particular, with regard to patent rights, numerous so-called “sleeping” patent rights that have not been used yet exist, it is strongly desired to devise liquidity and effective use of these patent rights, and contribute to economic activation.

In order to respond to these social needs, various countermeasures for promoting liquidity of patent rights in particular have been devised, such as establishment of institutions for enabling the sleeping patent rights possessed by enterprises to be sold or bought (for example, TLO (Technology Licensing Organization)), or enabling patent rights and licenses to be sold or bought by subjecting these to securitization (creation of a property liquidity law), or the like.

On account of this, there is demand for establishment of patent circulation and technology transfer markets wherein sellers and buyers handling a wider range of patent rights can participate, and development of an intellectual property right selling/buying system for managing the market effectively, as soon as possible.

### DISCLOSURE OF INVENTION

It is effective to perform selling/buying an intellectual property right in a market through a professional broker (or intermediary agency) having broad experience on selling/buying thereof. With regard to an intellectual property right providing enterprise for selling an intellectual property right, it is desirable for a broker to purchase the intellectual property right to be sold, from the aspect of fund management. However, in the event that a broker purchases and sells an intellectual property right to be sold, it is commonplace for a broker serving as a dealer to set an abnormal initial price and list it, in this case, the market falls into disorder, and consequently, promotion of circulation regarding intellectual property rights in the market is inhibited.

The present invention has been made in light of the above-described current situation, and accordingly, it is an object of the present invention to provide an intellectual property right selling/buying system, an intellectual property selling/buying method, a program thereof, and a recording medium, whereby an intellectual property right is listed at a reasonable price by monitoring the initial price set by a dealer, and circulation of intellectual property rights is promoted.

The present invention has been made to solve the above-described problems, and the intellectual property right selling/buying system according to the present invention for listing sales information of a right regarding intellectual property, and also accepting a bid application presenting a purchase price corresponding to the right, the intellectual property right selling/buying system comprises: price evaluation computing means for referring to a database retaining the right status of the right to be sold and evaluation data to be used for evaluating the right, and determining the value evaluation price of the right to be sold; and initial price monitoring means for capturing a listing initial price to be input based on a value evaluation price to be determined by the price evaluation computing means, and invalidating the initial price to be input when the captured initial price exceeds a predetermined upper limit price.

According to the present invention, the initial price monitoring means captures a listing initial price to be input based on a value evaluation price to be determined by the price evaluation computing means, and the input initial price is invalidated when the captured initial price exceeds a predetermined upper limit price, whereby a dealer is prevented from yielding unfair profits by setting abnormal initial prices, and also circulation of intellectual property rights can be promoted by setting initial prices relatively low.

Also, with the present invention, a predetermined upper limit price is calculated by α×(1+γ), wherein α is a value evaluation price to be calculated by the price evaluation computing means, and γ is a coefficient in a range of 0<γ<1.

According to the present invention, setting an initial price twice as large as the value evaluation price thereof or less prevents a dealer from yielding unfair profits by setting the initial price abnormally, and further, setting the initial price relatively low promotes circulation of intellectual property rights.

Also, with the present invention, in the event that the initial price input and captured by the initial price monitoring means is invalidated a predetermined number of times, the initial price is substituted with a value obtained by adding a predetermined price to a value evaluation price to be calculated by the price evaluation computing means.

According to the present invention, forcing an initial price to be set low penalizes the dealer, thereby promoting circulation of intellectual property rights.

Also, with the present invention, a price range is provided in a value evaluation price to be calculated by the price evaluation computing means, the coefficient γ to be set in each price range is in a range of 0<γ<0.3, and the higher the price range becomes, the lower the coefficient γ is set.

According to the present invention, setting the price range and the coefficient γ to a generally inverse proportional relation prevents a dealer from yielding unfair profits by setting initial prices abnormally even in the event that a call option is not used, and further, setting an initial price relatively low promotes circulation of intellectual property rights. In the event that the call option is not used, adding a maximum of 30% level to an initial price should be reasonable.

Also, with the present invention, a predetermined upper limit price is set depending on a call option fee that is calculated and paid based on a selling period and the value evaluation price.

According to the present invention, since a predetermined upper limit price can be set to a generally proportional relation with the option fee which was paid to a buyer from a dealer, an arrangement may be made wherein the higher the option fee is paid, the more profits a dealer can yield.

Also, with the present invention, the number of times a buying/selling right regarding the intellectual property has been bought/sold is counted, and the upper limit price is set depending on the number of times to be accumulated.

According to the present invention, since a predetermined upper limit price can be set to a generally proportional relation with selling/buying record, dealers having excellent selling/buying record obtain preferred treatment.

Also, with the present invention, the number of rights regarding the intellectual property of which the sales information is listed is recognized for each technology field, and the smaller the number of the rights listed, the higher the upper limit price of the corresponding technology field is set.

According to the present invention, since a predetermined upper limit price has a generally inverse proportional relation with the number of the intellectual property rights listed for each technology field, thereby promoting circulation of scarce rights in a market.

Also, with the present invention, a predetermined upper limit price is selected and output by searching a database including at least a value evaluation price to be determined by the price evaluation computing means, and the calculation ratio of the call option fee as data elements.

According to the present invention, establishing and searching the above-described database enables an upper limit price to be set more precisely and to be selected.

Also, with the present invention, when a predetermined upper limit price is calculated by α×(1+βX), wherein α is a value evaluation price to be calculated by the price evaluation computing means, and X is a call option ratio, the higher the price range set regarding a value evaluation price to be calculated by the price evaluation computing means becomes, the lower the coefficient β is set.

According to the present invention, setting the evaluation price range and the coefficient β to a generally inverse proportional relation prevents a dealer from yielding unfair profits by setting initial prices abnormally, thereby promoting circulation of intellectual property rights.

Also, with the present invention, when a predetermined upper limit price is calculated by α×(1+βX+δ), wherein α is a value evaluation price to be calculated by the price evaluation computing means, and X is a call option ratio, the higher the price range set regarding a value evaluation price to be calculated by the price evaluation computing means becomes, the lower the coefficient β is set, on the other hand, the greater the number of the performance of selling/buying a right becomes, the higher the coefficient δ is set, or the smaller the number of rights regarding the intellectual property of which the sales information is listed becomes, the higher the coefficient δ of the corresponding technology field is set.

According to the present invention, since a predetermined upper limit price can be set to a generally proportional relation with selling/buying record, dealers having excellent selling/buying record obtain preferred treatment. Also, since a predetermined upper limit price has a generally inverse proportional relation with the number of the intellectual property rights listed for each technology field, thereby promoting circulation of scarce rights in a market.

Also, with the present invention, in the event that the initial price input and captured by the initial price monitoring means is invalidated predetermined number of, the initial price is substituted with a value obtained by adding a call option fee to a value evaluation price to be calculated by the price evaluation computing means.

According to the present invention, while forcing an initial price to be set low penalizes the dealer, the option fee is recovered as the minimal compensation.

Also, the present invention is an intellectual property right selling/buying method for listing sales information of a right regarding intellectual property, and also accepting a bid application presenting a purchase price corresponding to the right, and the intellectual property right selling/buying method comprises: a price evaluation computing step for referring to a database retaining the right status of the right to be sold and evaluation data to be used for evaluating the right, and determining the value evaluation price of the right to be sold; and an initial price monitoring step for capturing a listing initial price to be input based on a value evaluation price to be determined in the price evaluation computing step, and invalidating the initial price to be input when the captured initial price exceeds a predetermined upper limit price.

Also, the present invention is an intellectual property right selling/buying program for listing sales information of a right regarding intellectual property, and also accepting a bid application presenting a purchase price corresponding to the right, and the intellectual property right selling/buying program controls a computer to perform: price evaluation computing processing for referring to a database retaining the right status of the right to be sold and evaluation data to be used for evaluating the right, and determining the value evaluation price of the right to be sold; and initial price monitoring processing for capturing a listing initial price to be input based on a value evaluation price to be determined in the price evaluation computing processing, and invalidating the initial price to be input when the captured initial price exceeds a predetermined upper limit price.

Also, the present invention is a computer-readable recording medium recording an intellectual property right selling/buying program for listing sales information of a right regarding intellectual property, and also accepting a bid application presenting a purchase price corresponding to the right, and the intellectual property right selling/buying program controls a computer to perform: price evaluation computing processing for referring to a database retaining the right status of the right to be sold and evaluation data to be used for evaluating the right, and determining the value evaluation price of the right to be sold; and initial price monitoring processing for capturing a listing initial price to be input based on a value evaluation price to be determined in the price evaluation computing processing, and invalidating the initial price to be input when the captured initial price exceeds a predetermined upper limit price.

According to the present invention, an intellectual property right is listed in a reasonable price by monitoring an initial price set by a dealer, a dealer is prevented from yielding unfair profits by setting and listing abnormal initial prices, and also circulation of intellectual property rights can be promoted. Further, though a dealer is given opportunities to list an initial price that is permitted to be set a predetermined number of times, in the event that all of the listings are determined as invalid initial prices, forcing a low initial price to be set imposes sanctions on the dealer as a penalty, and also adding a call option fee to a evaluation price as a low initial price enables the dealer to recover the option fee as the minimal compensation, and accordingly, the dealer does not lose.

It is needless to say that a dealer can accept sales of intellectual property rights at a cheap price, and can avoid risk in a case wherein they cannot be sold. Furthermore, value evaluation price, call option fee, and sale price can be automatically determined.

### BRIEF DESCRIPTION OF THE DRAWINGS

FIG. 1 is a diagram for describing the concept of an intellectual property trading market to which the present invention is applied.

FIG. 2 is a diagram for describing the overview of the flow of funds in an intellectual property right selling/buying system of the present invention.

FIG. 3 is a diagram illustrating the specific system configuration example of the intellectual property right trading market in the intellectual property right selling/buying system of the present invention.

FIG. 4 is a diagram illustrating the data configuration example of an option rate table.

FIG. 5 is a flowchart cited for describing a method for setting initial prices.

FIG. 6A through FIG. 6C are diagrams illustrating the example of a database used at the time of setting normal initial prices without using a call option.

FIG. 7 is a diagram illustrating the example of a database of initial price upper limits.

FIG. 8A through FIG. 8B are diagrams illustrating the example of a database for reflecting the number of times sold by dealers and the rate of the number of times sold in right fields, and obtaining upper limit prices.

FIG. 9 is a diagram for describing a method for calculating floating sale prices of intellectual property rights.

FIG. 10 is a diagram illustrating the example of an option rate-of-increase table.

FIG. 11 is a flowchart for describing the detailed flow of selling/buying procedures of intellectual property rights.

FIG. 12 is a block diagram illustrating the configuration example of Web site server.

### BEST MODE FOR CARRYING OUT THE INVENTION

<Concept of Intellectual Property Trading Market>

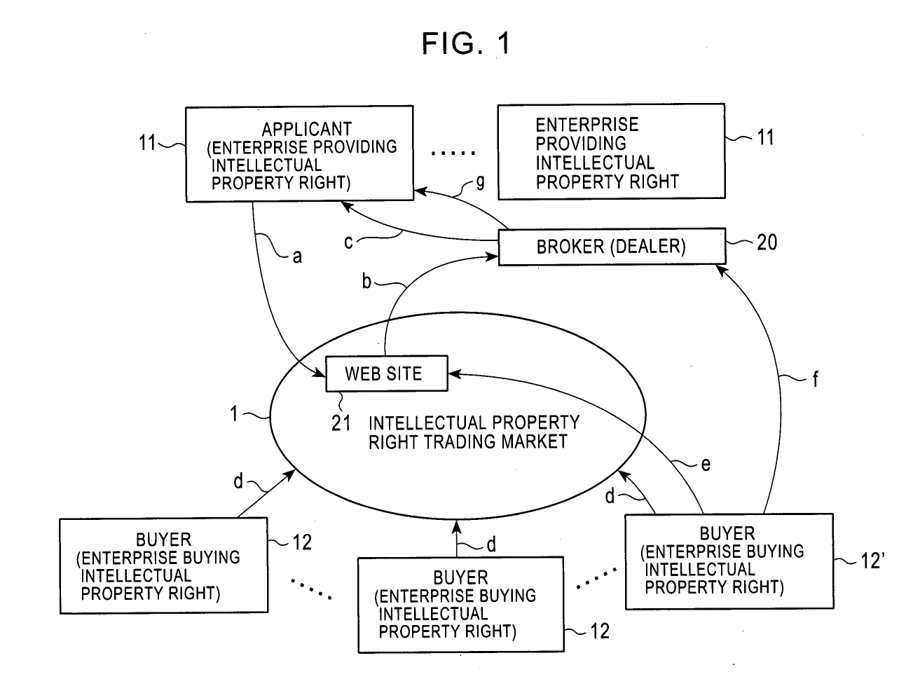

FIG. 1 is a diagram for describing the concept of an intellectual property right trading market to which an intellectual property right selling/buying system of the present invention is applied. Description will be made below regarding the intellectual property right trading market to which the present invention is applied, e.g., a Web site is applied with reference to FIG. 1.

An applicant (enterprise providing intellectual property right) 11 desiring to sell an intellectual property right such as a patent right applies to an Web site 21 for managing an intellectual property right trading market 1 for selling an intellectual property right to be sold (arrow-headed line a).

Next, a value evaluation price and a call option fee regarding the intellectual property right applied for selling are determined at the Web site 21, and these are presented to the applicant 11. In the event that the applicant 11 agrees with the presented value evaluation price and call option fee, a notification is posted on the Web site 21 to the effect, so as to notify a broker 20 (arrow-headed line b). Subsequently, in the event that the broker 20 purchases the selling/buying right of the intellectual property right to be sold, the broker 20 pays the call option fee to the applicant 11 (arrow-headed line c), and acquires the selling/buying right to the intellectual property right. At the Web site 21, the content of the intellectual property right to be sold, and the sale price thereof are listed on the intellectual property right trading market 1 (listed on the Web site 21).

On the other hand, a buyer (enterprise buying intellectual property right) 12 of an intellectual property right reads the intellectual property right listed on the intellectual property right trading market 1 (arrow-headed line d), and makes the Web site 21 an application for purchase (bid) (arrow-headed line e). Note that in the event that the multiple buyers 12 make an application for purchase, a buyer 12′ presenting the highest purchase price makes a successful bid.

Next, at the Web site 21, the application for purchase (bid) from the buyer 12′ is notified to the broker 20, upon the selling/buying of the intellectual property right being concluded, the buyer 12′ remits a purchase price to the broker 20 (arrow-headed line f).

In response to this, upon the broker 20 receiving the purchase price from the buyer 12′, the broker 20 pays a refund (value evaluation price−call option fee) to the applicant 11 (arrow-headed line g).

Note that in the event that an intellectual property right to be sold has been listed on the intellectual property right trading market 1 for a predetermined period (for example, one year), but a buyer 12 has not shown up, listing the intellectual property right is cancelled. This case results in a loss of the call option fee to the broker 20.

The intellectual property right selling/buying system of the present invention is applied under the assumption of the above-described intellectual property right trading market 1.

<Overview of Flow of Funds>

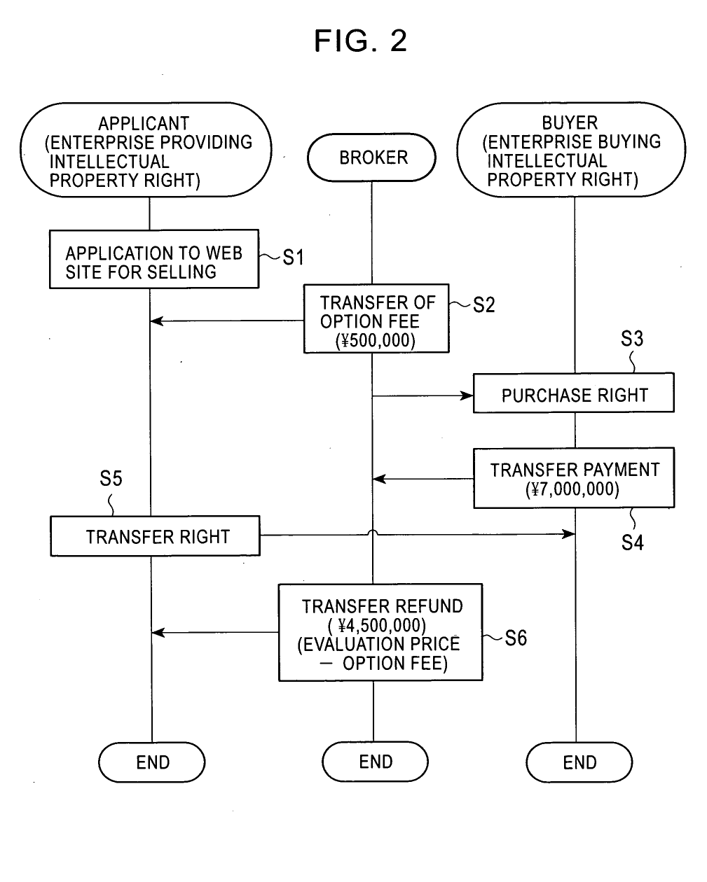

Next, description will be made regarding the overview of the flow of funds in the intellectual property right selling/buying system of the present invention with reference to FIG. 2. Here, description will be made on the assumption that the evaluation price of the intellectual property right to be sold is ¥5,000,000.

First, the applicant (enterprise providing intellectual property right) 11 desiring to sell an intellectual property right applies to the Web site 21 (intellectual property right trading market) for selling of an intellectual property right (Step S1). At this time, a desired selling period is also applied for.

Next, the broker 20 desiring to purchase the selling/buying of an intellectual property right to be sold pays, for example, ¥500,000 which is equivalent to 10% of the value evaluation price of the intellectual property right to the applicant 11 as a call option fee (Step S2). The term “call option” means a right to purchase an intellectual property right to be sold at a certain price and a right to sell it to a buyer at a free price during a certain period.

Next, in the event that the intellectual property right is sold at ¥7,000,000, the buyer (enterprise buying intellectual property right) 12 desiring to purchase the intellectual property right remits the purchase price, ¥7,000,000 to the broker 20 (Step S3 and S4).

Next, upon the transfer registration of the intellectual property right from the applicant 11 to the buyer 12 being completed (Step S5), the broker 20 pays ¥4,500,000 obtained by subtracting the call option fee from the value evaluation price, i.e., ¥5,000,000−¥500,000 to the applicant 11 from ¥7,000,000 received (Step S6).

Note that an arrangement may be made wherein the applicant 11 and the broker 20 determine a negotiation price (for example, ¥6,000,000) with reference to the value evaluation price (¥5,000,000), and a call option fee and refunds are calculated depending on this negotiation price.

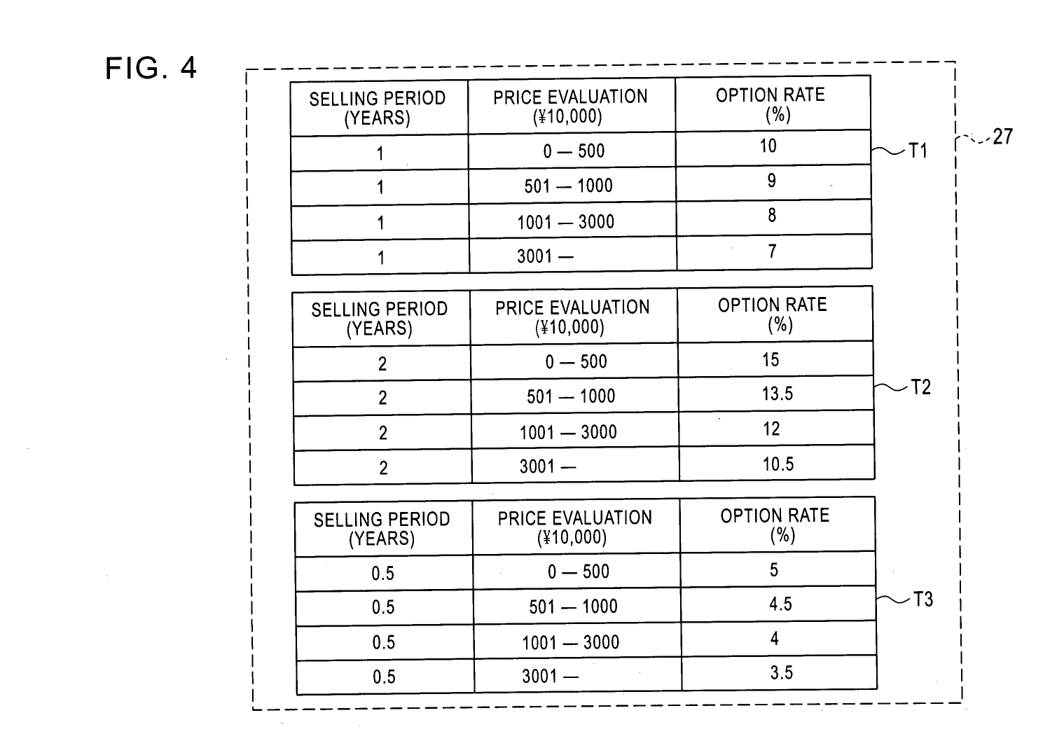

For example, in the case wherein the value evaluation price is ¥5,000,000, negotiation price is ¥6,000,000, call option fee is ¥540,000 as 9% of the negotiation price (i.e., the option rate corresponding to the price range of the value evaluation price included in the negotiation price ¥6,000,000 in Table T1 in FIG. 4), and the sale price is ¥7,000,000, the broker 20 makes a profit of ¥1,000,000, obtained by ¥7,000,000−(¥540,000+¥5,460,000).

<Specific System Configuration of Intellectual Property Right Trading Market>

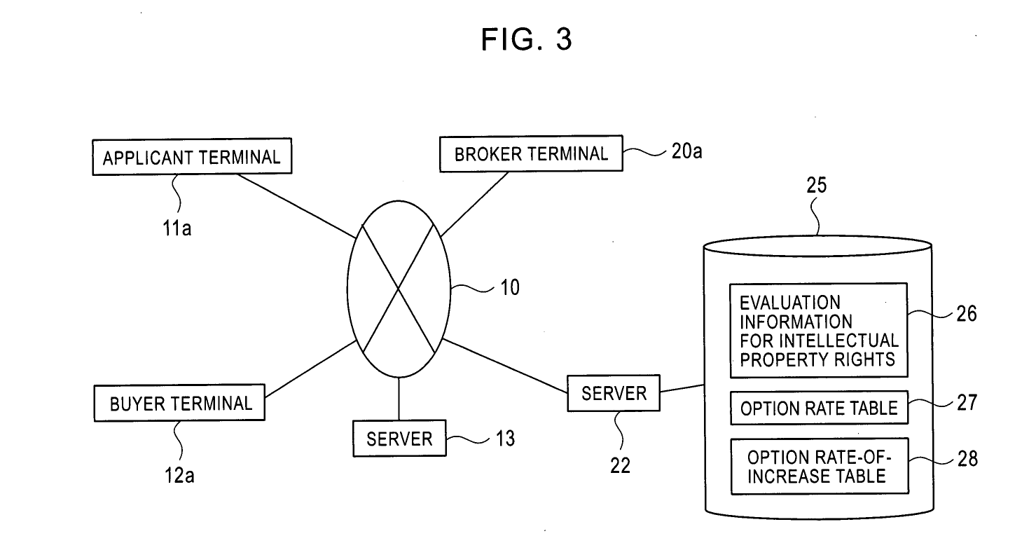

Next, description will be made regarding the specific system configuration of the intellectual property right trading market in the intellectual property right selling/buying system of the present invention with reference to FIG. 3. In FIG. 3, 11a denotes an applicant terminal possessed by the applicant 11 applying for selling of an intellectual property right such as a patent right, 12a denotes a buyer terminal possessed by the buyer 12 desiring to purchase an intellectual property right such as a patent right, 13 denotes a server installed in an evaluation organization for performing price evaluation of intellectual property rights, and 20a denotes a broker terminal possessed by the broker 20 selling the selling/buying right of an intellectual property right. 22 denotes a server for managing an Web site for establishing the intellectual property right trading market 1 on the Internet 10, and selling/buying intellectual property rights in an auction form. 25 denotes a database within the server 22, and is made up of evaluation information for intellectual property rights 26, an option rate table 27, and an option rate-of-increase table 28.

With the intellectual property right selling/buying system of the present invention, the server 22 in the Web site 21 serves as the core thereof, and the intellectual property right trading market is established on the Internet 10, whereby selling/buying intellectual property rights such as patent rights to be sold can be performed.

<Specific Management Example of Call Option>

Next, description will be made regarding the specific management example of the call option according to the present invention.

(1) Method for Determining Call Option Fee

A call option fee is determined using an option rate defined in the database beforehand. FIG. 4 is a diagram illustrating the table configuration of the option rate table 27 retained in the database 25.

With the call option rate table 27 shown in FIG. 4, the option ratio (%) varies depending on the selling period (listing period (year) on the intellectual property trading market 1), the value evaluation price (¥10,000), and the call option fee can be calculated using the following expression.
call option fee=value evaluation price (¥10,000)×option rate (%)/100

Here, description will be made on the assumption that the option rate table 27 comprises a table T1 in the case wherein the selling period is one year, a table T2 in the case wherein the selling period is two years, and a table T3 in the case wherein the selling period is a half year. With respective tables T1, T2, and T3, option rates are defined for each price range of the respective value evaluation prices. For example, in the event that the selling period is one year, the option rate of a value evaluation price is defined such that value evaluation prices ¥0 through ¥5,000,000 is 10%, hereinafter in the same way, ¥5,010,000 through ¥10,000,000 is 9%, ¥10,010,000 through ¥30,000,000 is 8%, and ¥30,010,000 or more is 7%. The call option fee to be paid by the broker 20 to the applicant 11 is calculated based on the option rates defined in this table.

Note that an arrangement may be made wherein a call option fee may be calculated uniformly using the following expression without using the table shown in FIG. 4.
call option fee=value evaluation price (¥10,000)×10%×selling period (year)/100
(2) Method for Setting Initial Prices

Description will be made regarding how to set a publicly-offered sale price (initial price) in the case of listing the price on the intellectual property right trading market 1 with reference to the flowchart illustrated in FIG. 5. In FIG. 5, the flow of data between the sever and the terminals possessed by the applicant (enterprise providing intellectual property right) 11, evaluation organization, broker 20, intellectual property right trading market 1, and buyer (enterprise buying intellectual property right) 12 respectively is illustrated.

First, the applicant terminal 11a of the applicant serving as a seller sends “application information for selling” his/her own patent right (or patent pending) to the broker terminal 20a of the broker (Step S51). Note that in the event of sending “application information for selling”, information such as Patent No. (or Patent Application No.) and a desired sale price are sent together.

Next, the broker terminal 20 accepts the application for selling of the patent right, sends the information regarding the right to be applied for selling is sent to the server 13 of the evaluation organization to commission evaluation thereof (Step S52).

Subsequently, at the evaluation organization, a professional team performs price evaluation regarding the patent right of which the evaluation request is received, inputs the evaluation results into the server 13 (Step S53), and sends the input evaluation results to the broker terminal 20a of the broker and the applicant terminal 11a of the applicant (Step S54).

Next, the applicant operates the applicant terminal 11a, determines whether or not to sell the patent right with reference to the evaluation results (Step S55), and sends confirmation for selling to the broker 20a of the broker (Step S56). Upon the broker terminal 20a receiving the confirmation for selling from the applicant via the applicant terminal 11a, the broker determines that negotiation is successful (Step S57), sets an initial price, and lists this on the intellectual property right trading market 1, i.e., lists this on the Web site 21 (Step S58). With the initial price thus set, the upper value thereof is checked by the server 22 in the Web site 21 (Step S59).

The server 22 in the Web site 21 acquires the initial price set via the broker terminal 20a by the broker, and invalidates the acquired initial price upon exceeding a predetermined upper limit price, e.g., twice as large as the value evaluation price received from the server 13 of the evaluation organization. Here, a predetermined upper limit price is calculated by α×(1+γ), wherein α is a value evaluation price, γ is a coefficient in a range of 0<γ<1.

As described above, the initial price set by the broker serving as a dealer is held down by setting the upper limit price equal to or less than twice as large as the value evaluation price. Thus, confusion in the market caused by abnormal initial prices set by a dealer is prevented, dealers are prevented from yielding unfair profits, and also circulation of intellectual property rights can be promoted. Note that, here, an initial price can be set again, i.e., up to three times (Step S60). In the event that the initial price set is invalidated three times, the price obtained by adding a predetermined price, e.g., a price equivalent to the call option fee to the value evaluation price is forcibly determined as an initial price (Step S61). Subsequently, the determined initial price is notified to the broker via the broker terminal 20a (Step S62), listed on the intellectual property right trading market (Step S63), and viewing using the buyer terminal 12a of the buyer is permitted (Step S64).

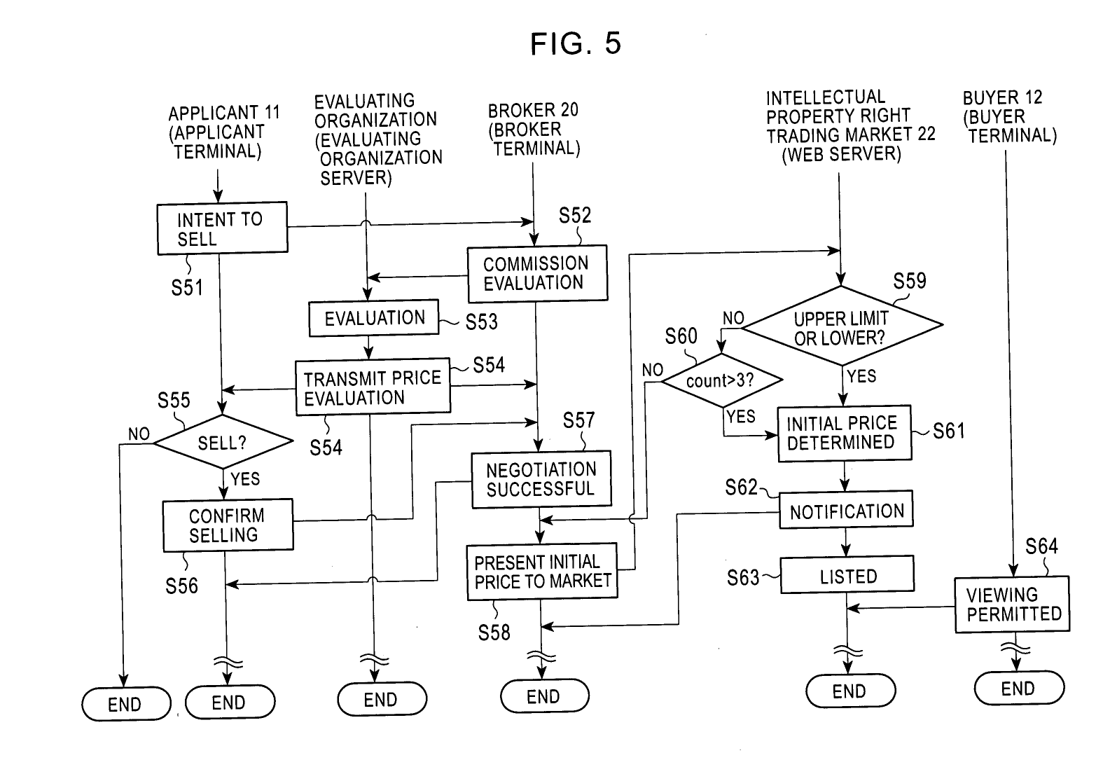

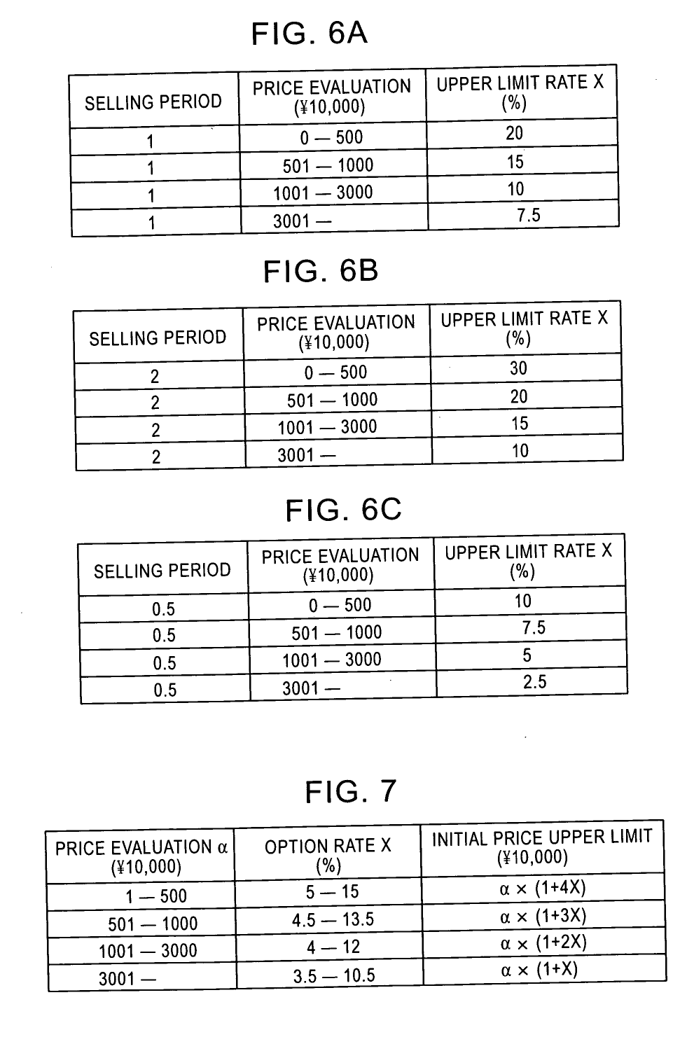

Note that an arrangement may be made wherein a price range is provided for evaluation prices, a coefficient γ to be set in each price range is in a range of 0<γ<0.3, and the higher the price range becomes, the lower the coefficient γ is set. In this case, setting the evaluation price range and coefficient γ to a generally inverse proportional relation prevents a dealer from yielding unfair profits by setting initial prices abnormally even in the event that the call option is not used. In the event that the call option is not used, adding a maximum of 30% level to an initial price should be reasonable. FIG. 6A through FIG. 6C illustrate the upper limit rates in the case wherein the call option is not used.

Also, it is possible to set an upper limit price depending on the amount of the call option fee to be paid, in this case, as illustrated in FIG. 4, an arrangement may be made wherein a database including a selling period, value evaluation prices, and call option rates as data elements is searched, and an option rate is selected, and the selected option rate is multiplied with a coefficient (β) as shown in FIG. 7, whereby the higher the option fee is paid, the more profits can be yielded, and also an upper limit price can be set more precisely.

Furthermore, an arrangement may be made wherein when an upper limit price is calculated by α×(1+βX), wherein a is a value evaluation price, and X is a call option ratio, the higher the price range becomes, the lower the coefficient β is set. FIG. 7 is a diagram illustrating the example of a database of initial price upper limits.

In this case, setting the price range and coefficient β to a generally inverse proportional relation prevents a dealer from yielding unfair profits by setting initial prices abnormally, thereby promoting circulation of intellectual property rights. Also, in this case as well, as described above, in the event that the input and acquired initial price is invalidated a predetermined number of times, the price obtained by adding the call option fee to the value evaluation price is forcibly determined as an initial price. Thus, while penalizing the dealer, the option fee can be recovered as the minimal compensation.

Note that in the event of an arrangement wherein the call option is not used, when the initial price is invalidated a predetermined number of times, the price obtained by adding 5% to the value evaluation price becomes an initial price.

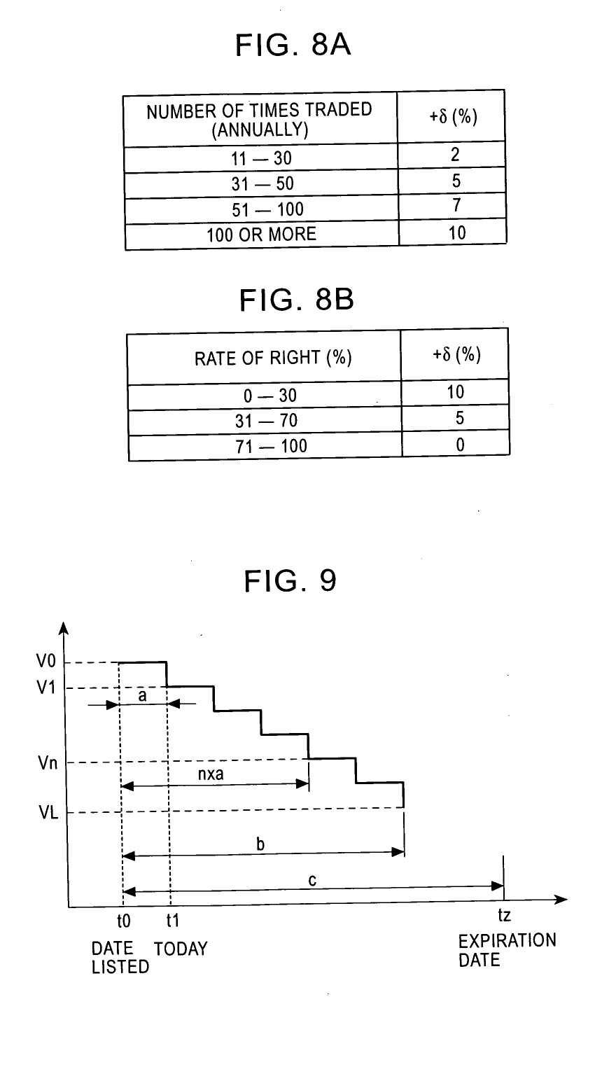

Alternatively, as other factors to determine an upper limit price, an arrangement may be made wherein a point is given to each dealer depending on the selling record of the dealer (the number of times of trading), with a higher upper limit rate being applied to dealers having excellent selling records. FIG. 8A illustrates the configuration example of a database for reflecting the number of times traded by dealers. In the drawing, an arrangement is made wherein an upper limit rate is determined due to the number of times traded, and dealers having good selling/buying records obtain preferred treatment.

Furthermore, an arrangement may be made wherein intellectual property rights circulating in the market, e.g., the number of patent rights for each technology field is surveyed, and a high upper limit rate is applied to the small number of the fields based on the surveyed results. FIG. 8B illustrates the configuration example of a database which the number of each technology field is reflected. In the drawing, an arrangement is made wherein an upper limit rate is determined according to the rate of the rights (the number of specific field rights/the number of the entire rights), thereby promoting circulation of the scarce rights in the market. Here, while patent rights have been described as a technology field example, this can be applied to the other fields such as design rights, trademark rights, and copyrights as well.

Note that the above-described both two factors are applied to not only a normal case but also a case wherein the call option is used, and accordingly, the upper limit prices can be set more precisely. The upper limit prices are calculated with α×(1+βX+δ) in a case using the call option, and with X+δ in a normal case.

(3) Case of Reflecting Fluctuation in Price of Intellectual Property Rights on Sale Prices

Also, as illustrated in FIG. 9, in the event that intellectual property rights listed on the intellectual property right trading market 1 are patent rights, or utility model rights, the worth thereof decreases depending on the remaining period of the right and technical lifetime. In the event of reflecting this on sale prices, for example, sale prices are calculated such as shown in the following.

A first calculation of a floating sale price is performed at the time of a current date t1 when “a certain period a” has been elapsed since a date t0 when a patent right to be sold has been listed on the trading market (listed on the Web site 21), hereinafter the calculation of a floating sale price is performed using the following expression each time the “period a” is elapsed.
changed sale price Vn (sale price at the n'th calculation)=sale price prior to change V0×(1−n×a/c)

Here, n represents the number of times a floating sale price has been calculated.

A “basic days-to-expiration c” within the above expression denotes the basic days-to-expiration of a patent right to be sold at the time of calculating a floating sale price, and is obtained by comparing the expiration date of a patent right remaining period since a listing date with the final date of a technical lifetime, and employing a period up to whichever date is closer.

In an example illustrated in FIG. 9, while the sale price is gradually reduced step by step each time a calculation is performed, upon the sale price reaching a minimal limit price VL shown in the following expression or less, subtraction of the floating sale price is suspended.
minimal limit price VL=initial sale price−call option fee=value evaluation price
(4) Regarding Increase of Call Option Fee

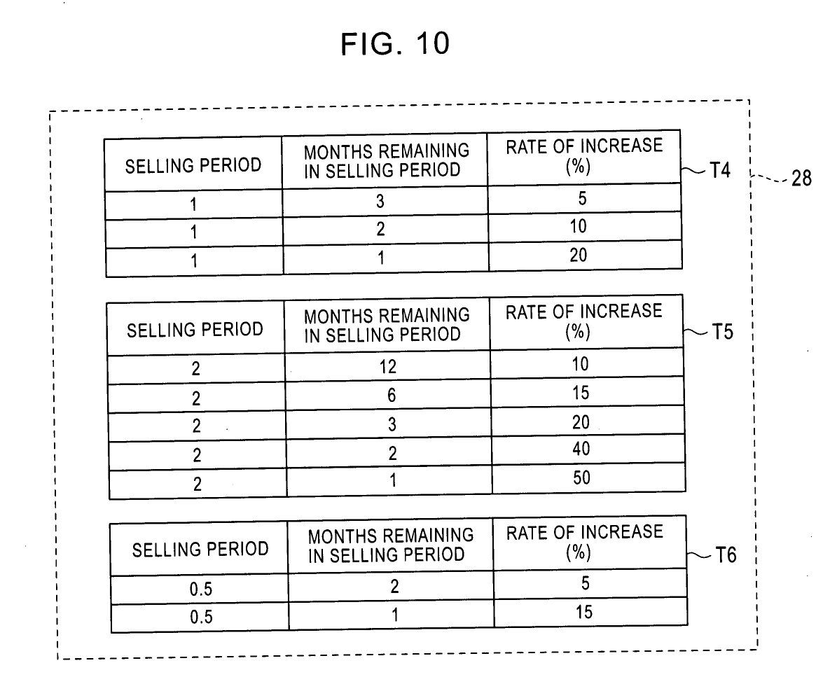

Also, FIG. 10 is a diagram illustrating an example of an option rate-of-increase table 28. This table is a table to be referred to in the event that the remaining period (remaining months) of a selling period has ended, and in the event that the call option fee is increased depending on the selling period and the remaining months of the selling period. Here, description will be made on the assumption that the option rate-of-increase table 28 comprises a table T4 in the case wherein a selling period is one year, a table T5 in the case wherein a selling period is two years, and a table T6 in the case wherein a selling period is a half year. With the respective tables T4, T5, and T6, an increase rate is defined for each of the remaining moths of the corresponding selling period. For example, in the event that a selling period is one year, the increase rate in the case wherein the remaining months of the selling period is 3 is defined as 5%, hereinafter in the same way, the increase rate in the case wherein the remaining months of the selling period is 2 is defined as 10%, and the increase rate in the case wherein the remaining months of the selling period is 1 is defined as 20%.

The increase of a call option fee is a method used for prompting the broker 20 to sell an intellectual property right. In other words, with this trading arrangement, since a right to be sold is one, following waiting for a certain period, a deal is established for the highest asking price of multiple asking prices (purchase prices). However, with this method, the broker 20 is prompted to sell the right quickly, and the selling period is shortened, resulting in selling the right at a reasonable price.

Also, an arrangement may be made wherein keeping the relation of “current sale price−increased call option amount<value evaluation price” prevents a call option fee from increase even if the period expires. Thus, brokers can be prevented from taking a loss.

<Operation of Selling/Buying Procedures of Intellectual Property Right>

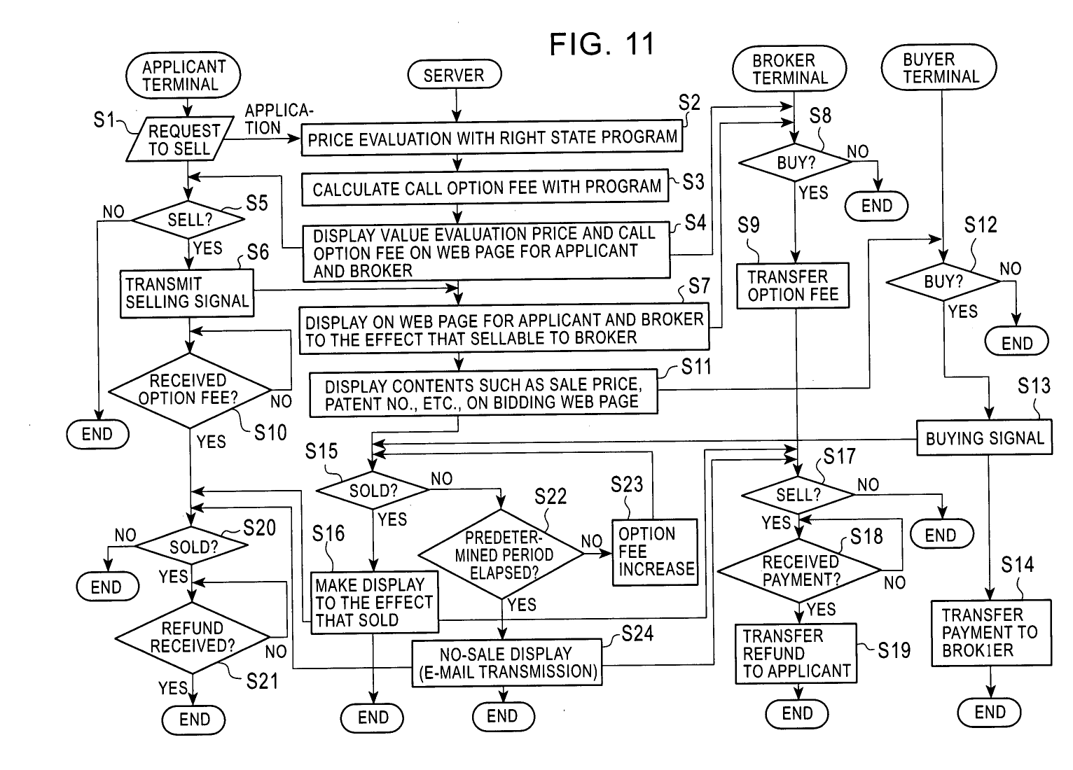

Next, description will be made regarding the detailed flow of selling/buying procedures of an intellectual property right in the intellectual property right trading market 1 illustrated in FIG. 3 with reference to FIG. 11.

First, the applicant 11 sends information of “application for selling (request to selling application)” of an intellectual property right such as his/her own patent right from the applicant terminal 11a to the server 22 in the Web site 21 (Step S1).

Next, the server 22 in the Web site 21 accepts “application for selling.”, makes a reference of the evaluation information for intellectual property rights 26 within the database 25, and determines the state of the right and value evaluation price of the intellectual property right to be sold (Step S2). Note that in the event that the information regarding the intellectual property right to be sold is not included in the database 25, necessary information is acquired from an external intellectual property right information providing organization (“Japan Patent Information Organization” and the like, in the case of patent rights), and registered in the database 25.

Next, following determining the value evaluation price, the server 22 makes reference to the option rate table 27 within the database 25, and calculates a call option fee (Step S3).

Subsequently, the server 22 displays the value evaluation price and call option fee on a Web page for applicants and brokers (Step S4). Also, the server 22 sends the value evaluation price and call option fee to the applicant terminal 11a of the applicant 11 and the broker terminal 20a of the broker 20 by e-mail.

In response to this, the applicant terminal 11a of the applicant 11 receives the information of the value evaluation price and call option fee from the server 22 in the Web site 21, and determines whether or not the intellectual property right to be sold is sold at the value evaluation price and call option fee (Step S5). In the event of selling the right, the applicant terminal 11a of the applicant 11 sends a “selling signal” to the effect that selling is approved to the server 22 in the Web site 21 (Step S6).

Next, in the event that the server 22 in the Web site 21 receives the “selling signal” from the applicant terminal 11a of the applicant 11, makes a display “to the effect that the right is sellable” on the Web page for applicants and brokers (Step S7).

Next, the broker 20 sends the call option fee to the applicant in the event of purchasing the selling/buying right of the intellectual property right to be sold (Steps S8 and S9). Also, the broker terminal 20a of the broker 20 sends the information to the effect that the applicant 11 paid the call option fee to the server 22 in the Web site 21. Also, at the applicant terminal 11a of the applicant 11, determination is made whether or not the call option fee has been received (Step S10).

Next, the server 22 in the Web site 21 displays the content of the intellectual property right to be sold (Patent No. or sale price) on a Web page for bidding (Step S11), and accepts the bid of the buyer 12.

In response to this, in the event that the buyer 12 purchases the intellectual property right to be sold, the buyer terminal 12a of the buyer 12 sends a “buying signal” to the server 22 in the Web site 21 (Steps S12 and S13). Also, in the event that trading is successful, the buyer 12 transfers “payment” to the broker 20 (Step S14).

Also, in the event that the server 22 in the Web site 21 receives the “buying signal” from the buyer terminal 12a of the buyer 12, the server 22 makes a display “to the effect that the right is sold” on the Web page for applicants and brokers, and notifies this to both the applicant and the broker (Steps S15 and S16). Alternatively, the server 22 in the Web site 21 sends “to the effect that the right has been sold” by e-mail to the applicant terminal 11a of the applicant 11 and the broker terminal 20a of the broker 20.

Next, the broker 20 who has received the notification “to the effect that the right has been sold” from the server 22 in the Web site 21 determines whether or not to sell the right (Step S17), in the event of selling the right, receives the payment from the buyer 12 (Step S18). Also, in the event of receiving the payment from the buyer 12, the broker 20 transfers refunds (value evaluation price−call option fee) to the applicant 11 (Step S19). The applicant 11 receives the refunds (Steps S20 and S21).

On the other hand, in the event that the intellectual property right to be sold remains unsold, and the remaining period of the selling period reaches a certain number of months or less, the server 22 penalizes the broker 20 by increasing the call option fee for each certain period (Steps S22 and S23).

Or, in the event that the intellectual property right to be sold is remained unsold, and the selling period is elapsed, the server 22 makes a display “to the effect that the right is not sold” on the Web page for applicants and brokers (Steps S22 and S24). Alternatively, the server 22 sends “to the effect that the right is not sold” to the applicant terminal 11a of the applicant 11 and the broker terminal 20a of the broker 20 by e-mail.

<Configuration of Server in Web Site>

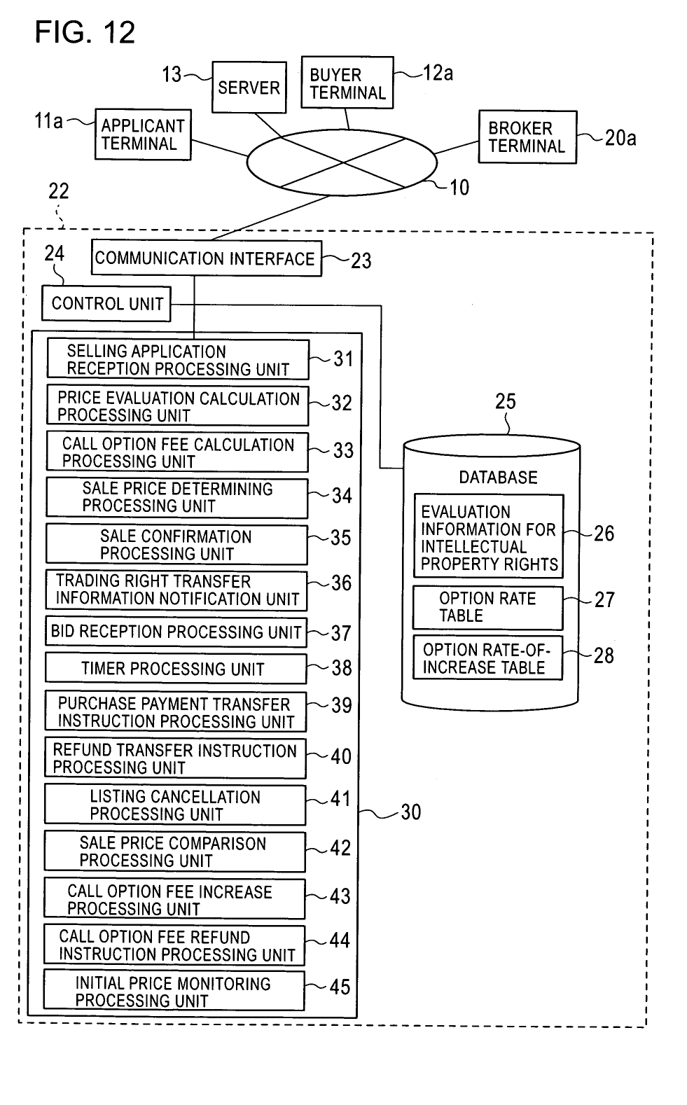

Next, description will be made regarding the configuration of the server 22 in the Web site 21 with reference to FIG. 12. FIG. 12 illustrates only a part of the configuration of the server 22 directly relevant to the present invention. In FIG. 12, 23 denotes a communication interface for connecting the server 22 to the Internet 10, 24 denotes a control unit for integrally controlling the entire server 22, and 25 denotes a database.

The evaluation information for intellectual property rights 26 of the database 25 is information for performing price evaluation of an intellectual property right applied for selling. In the event that the information of the intellectual property right applied for selling is not included in the database 25, necessary information is acquired from an external intellectual property right information providing organization (“Japan Patent Information Organization” and the like, in the case of patent rights), and registered on the database 25. Also, the option rate table 27 records the option rate information used for calculating a call option fee as described above. As described above, the remaining period of the selling period reaches a certain number of months or less, and the call option fee is increased for each certain period. The option rate-of-increase table 28 is a table used in the case of calculating this increase.

A processing program unit 30 includes the following processing units.

A selling application reception processing unit 31 is a processing unit for receiving information of the application for selling of an intellectual property right, the content of the right, the selling period thereof from the applicant terminal 11a of the applicant 11. A price evaluation calculation processing unit 32 is a processing unit for referring to the database 25 retaining the right situation of a right to be sold and the information for evaluating the right, and determining the value evaluation price of a right to be sold. A call option fee calculation processing unit 33 is a processing unit for referring to the option rate table 27, and calculating a call option fee based on a selling period and value evaluation price. A sale price determining processing unit 34 is a processing unit for determining the sale price of an intellectual property right to be sold based on a value evaluation price and the call option fee. A sale confirmation processing unit 35 is a processing unit for sending information of a value evaluation price, the call option fee, and a sale price to the applicant terminal 11a of the applicant 11, and receiving “sale confirmation information” to the effect that sale is approved from the applicant terminal 11a of the applicant 11. A trading right transfer information notification unit 36 is a processing unit for receiving “sale confirmation information” from the applicant terminal 11a of the applicant 11, either listing on the Web site that the trading right of an intellectual property right to be sold can be transferred to the broker 20, or notifying that to the broker terminal 20a of the broker 20 by e-mail.

A bid reception processing unit 37 is a processing unit for listing the sale information of an intellectual property right to be sold on a Web site, and accepting a bid from the buyer terminal 12a of the buyer 12. A timer processing unit 38 is a processing unit for monitoring a date when the sale information of an intellectual property right to be sold is listed on the Web site, and a selling period. A purchase payment transfer instruction processing unit 39 is a processing unit for sending transfer instruction information of purchase payment as to the broker 20 to the buyer terminal 12a of the buyer 12 in the event that there is an application for purchase from the buyer terminal 12a of the buyer 12, and trading thereof is successful. A refund transfer instruction processing unit 40 is a processing unit for sending transfer instruction information of refunds (value evaluation price−call option fee) as to the applicant 11 to the broker terminal 20a of the broker 20 in the event that there is an application for purchase from the buyer terminal 12a of the buyer 12, trading thereof is successful, and the intellectual property right is transferred to the buyer 12 from the applicant 11. A listing cancellation processing unit 41 is a processing unit for canceling listing an intellectual property right to be sold on the Web site in accordance with a signal from the timer processing unit 38, and also sending a “signal to the effect that trading was unsuccessful” to the broker terminal 20a of the broker 20 and the applicant terminal 11a of the applicant 11 in the event that a “buying signal” is not received from the buyer terminal 12a of the buyer 12, and also a selling period is elapsed.

A sale price comparison processing unit 42 is a processing unit for comparing a value evaluation price, a calculated price calculated from the call option fee, and a desired price of the applicant 11, and listing the content and sale price of an intellectual property right to be sold on the Web site, in the event that the desired price is equal to or less than the calculated price. Note that this sale price comparison processing unit 42 is provided as necessary. A call option fee increase processing unit 43 is a processing unit for increasing the call option fee for each certain period, and sending the information regarding increase of the call option fee to the broker terminal 20a of the broker 20 in the event that the remaining period of a selling period reaches a certain limit period or less. Note that this call option fee increase processing unit 43 is provided as necessary. A call option fee refund instruction processing unit 44 is a processing unit for sending refund instruction information of the call option fee paid to the applicant 11 to the applicant terminal 11a of the applicant 11 in the event that an intellectual property right to be sold is sold. Note that this call option fee refund instruction processing unit 44 is provided as necessary.

An initial price monitoring processing unit 45 is a processing unit for capturing a listing initial price input based on a value evaluation price determined by the price evaluation calculation processing unit 32, and invalidating an initial price to be input when the captured initial price exceeds a certain upper limit price. An upper limit price is obtained by calculating α×(1+γ) for example, wherein α is a value evaluation price calculated by the price evaluation calculation processing unit 32, and γ is a coefficient in a range of 0<γ<1. Also, the initial price monitoring processing unit 45 performs the processing for forcing the value obtained by adding a certain amount of money such as the call option fee to a value evaluation price calculated by the price evaluation calculation processing unit 32 to be set as an initial price in the event that the input and captured initial price is invalidated a certain number of times.

Note that this processing program unit 30 may be realized by dedicated hardware, or an arrangement may be made wherein this processing program unit is configured of a general-purpose information processing device such as memory and a CPU (Central Processing Unit), and the functions thereof are realized by loading a program (not shown) for realizing the functions of this processing unit to the memory, and executing this program. Also, the server 22 in this Web site is connected with an unshown input device, a unshown display device, and the like, as peripheral equipment. Here, the input device is an input device such as a keyboard or a mouse, and the display device is a CRT (Cathode Ray Tube), a liquid crystal display device, or the like.

Heretofore, while description has been made regarding the embodiment of the present invention, an arrangement may be made wherein a program for realizing the functions of the processing program unit 30 within the server 22 in the Web site illustrated in FIG. 12 is recorded in a computer-readable recording medium, a computer system reads and executes the program recorded in this recording medium, whereby processing necessary for the processing program unit 30 within the server 22 in the Web site illustrated in FIG. 12. Note that the above-described “computer system” includes an OS (Operating System) and hardware such as peripheral equipment.

Also, a “computer-readable recording medium” means a portable medium such as a flexible disk, optical disk, memory card, or CD-ROM, or a hard disk and so forth to be built in the computer system.

Furthermore, a “computer-readable recording medium” includes a medium (transmission medium or transmitted waves) for retaining a program dynamically for a short period such as a communication line in the case of transmitting a program via a network such as the Internet or the communication line such as a telephone line, and a medium for retaining a program for a certain period such as volatile memory within the computer system serving as a server or client in that case. Also, the above-described program may be a program for realizing a part of the aforementioned functions, or further a program for realizing the aforementioned functions in combination with the program already recorded in the computer system, i.e., a so-called difference file (difference program).

Heretofore, while description has been made regard the embodiment in the intellectual property right selling/buying system according to the present invention, the present invention is not restricted by the above-described examples illustrated by way of the drawings, and it is needless to say that various modifications can be made without departing from the spirit and scope of the invention. In particular, the present invention is not restricted to use of a Web site, and is applied to a general trading market using a computer system.

1. An intellectual property right selling/buying system for listing sales information of a right regarding intellectual property, and also accepting a bid application presenting a purchase price corresponding to said right, said intellectual property right selling/buying system comprising:
price evaluation computing means for referring to a database retaining a right status of said right to be sold and evaluation data to be used for evaluating said right, and determining a value evaluation price of said right to be sold; and
initial price monitoring means for capturing a listing initial price to be input based on the value evaluation price to be determined by said price evaluation computing means, and invalidating said initial price to be input when said captured initial price exceeds a predetermined upper limit price.

2. An intellectual property right selling/buying system according to claim 1, wherein said predetermined upper limit price is calculated by α×(1+γ), here, α is the value evaluation price to be calculated by said price evaluation computing means, and γ is a coefficient in a range of 0<γ<1.

3. An intellectual property right selling/buying system according to claim 1, wherein in the event that said initial price list input and captured by said initial price monitoring means is invalidated a predetermined number of times, said initial price is substituted with a value obtained by adding a predetermined price to the value evaluation price to be calculated by said price evaluation computing means.

4. An intellectual property right selling/buying system according to claim 2, wherein a price range is provided in the value evaluation price to be calculated by said price evaluation computing means, said coefficient γ to be set in each price range is in a range of 0<γ<0.3, and the higher said price range becomes, the lower said coefficient γ is set.

5. An intellectual property right selling/buying system according to claim 1, wherein said predetermined upper limit price is set depending on a call option fee that is calculated and paid based on a selling period and said value evaluation price.

6. An intellectual property right selling/buying system according to claim 1, wherein the number of times a buying/selling right regarding said intellectual property has been bought/sold is counted, and said upper limit price is set depending on said number of times to be accumulated.

7. An intellectual property right selling/buying system according to claim 1, wherein a number of rights regarding said intellectual property of which said sales information is listed is recognized for each technology field, and the smaller the number of the listing rights, the higher said upper limit price of the corresponding technology field is set.

8. An intellectual property right selling/buying system according to claim 5, wherein said predetermined upper limit price is selected and output by searching a database including at least the value evaluation price to be determined by said price evaluation computing means, and the calculation ratio of said call option fee as data elements.

9. An intellectual property right selling/buying system according to claim 5, wherein when said predetermined upper limit price is calculated by α×(1+βX), wherein α is the value evaluation price to be calculated by said price evaluation computing means, and X is a call option ratio, the higher the price range set regarding the value evaluation price to be calculated by said price evaluation computing means becomes, the lower the coefficient β is set.

10. An intellectual property right selling/buying system according to claim 6, wherein when said predetermined upper limit price is calculated by α×(1+βX+δ), wherein α is the value evaluation price to be calculated by said price evaluation computing means, and X is a call option ratio, the higher the price range set regarding a value evaluation price to be calculated by said price evaluation computing means becomes, the lower the coefficient β is set, on the other hand, the greater the number of said performance of selling/buying a right becomes, the higher the coefficient δ is set, or the smaller the number of rights regarding said intellectual property of which said sales information is listed becomes, the higher the coefficient δ of the corresponding technology field is set.

11. An intellectual property right selling/buying system according to claim 1, wherein in the event that said initial price list input and captured by said initial price monitoring means is invalidated a predetermined number of times, said initial price is substituted with a value obtained by adding a call option fee to a value evaluation price to be calculated by said price evaluation computing means.

12. An intellectual property right selling/buying method for listing sales information of a right regarding intellectual property, and also accepting a bid application presenting a purchase price corresponding to said right, said intellectual property right selling/buying method comprising:
a price evaluation computing step for referring to a database retaining a right status of said right to be sold and evaluation data to be used for evaluating said right, and determining a value evaluation price of said right to be sold; and
an initial price monitoring step for capturing a listing initial price to be input based on the value evaluation price to be determined in said price evaluation computing step, and invalidating said initial price to be input when said captured initial price exceeds a predetermined upper limit price.

13. An intellectual property right selling/buying program for listing sales information of a right regarding intellectual property, and also accepting a bid application presenting a purchase price corresponding to said right, said intellectual property right selling/buying program controlling a computer to perform:
price evaluation computing processing for referring to a database retaining a right status of said right to be sold and evaluation data to be used for evaluating said right, and determining a value evaluation price of said right to be sold; and
initial price monitoring processing for capturing a listing initial price to be input based on the value evaluation price to be determined in said price evaluation computing processing, and invalidating said initial price to be input when said captured initial price exceeds a predetermined upper limit price.

14. A computer-readable recording medium recording an intellectual property right selling/buying program for listing sales information of a right regarding intellectual property, and also accepting a bid application presenting a purchase price corresponding to said right, said intellectual property right selling/buying program controlling a computer to perform:
price evaluation computing processing for referring to a database retaining a right status of said right to be sold and evaluation data to be used for evaluating said right, and determining a value evaluation price of said right to be sold; and
initial price monitoring processing for capturing a listing initial price to be input based on the value evaluation price to be determined in said price evaluation computing processing, and invalidating said initial price to be input when said captured initial price exceeds a predetermined upper limit price.
